(19) United States
(12) Patent Application Publication
(10) Pub. No.: US 2026/0038208 A1
(43) Pub. Date: Feb. 5, 2026

(54) ROOM AXIS ESTIMATION

(71) Applicant: LexisNexis Risk Solutions FL Inc., Boca Raton, FL (US)

(72) Inventor: Victor Palmer, Denver, CO (US)

(21) Appl. No.: 18/792,829

(22) Filed: Aug. 2, 2024

(51) Int. Cl. G06T 19/00; G06T 7/70

(52) U.S. Cl. CPC G06T 19/006; G06T 7/70; G06T 2219/004

(57) ABSTRACT

Systems and methods are provided for estimating an axis of a room based on a computer vision scan of the room and its contents, and a process of axis majority voting. A method is provided that includes capturing a plurality of images of the interior environment having one or more walls and a plurality of objects, each wall and object having a surface oriented along a corresponding plane; determining, based on information received from an AR engine, local axis orientations for at least a portion of the walls and objects. The method includes estimating a room axis of the interior environment based on a voting process, wherein a majority of matching local axis orientations are utilized to determine the room axis; and outputting an indication of the room axis.

### FIELD OF THE INVENTION

The disclosed technology generally relates to systems and methods for estimating an axis of a room based on a computer vision scan of the room and its contents. Certain implementations may utilize a majority voting process to establish the room axis.

### BACKGROUND

Digital representations of interior physical structures (e.g., a room in a house or business) can facilitate efficient construction, maintenance, renovation planning, documentation, underwriting, etc. Once a room has been digitally captured, for example, additional dimensional details can be extracted from the model without requiring personnel to physically be in the room, or to use conventional measuring implements such as tape measures, yard sticks, rulers, and the like. Therefore, the ability to accurately and efficiently build a model of a room and its contents can help reduce costs associated with a variety of applications.

When generating a three-dimensional (3D) model of a room, for example, a typical goal is to derive mathematical representations of walls and contents of the room in terms of 3D world positions and orientations so that various viewpoints of the room can be rendered on a two-dimensional (2D) computer screen, which can enable details of the room to be measured and understood. In many instances, a top-down, 2D blueprint-style viewpoint of the room is preferred so that the axis of the room corresponds to the natural axis of the computer screen in which each pixel can be defined by an X, Y coordinate. However, when scanning a room to produce the 3D model, there are often objects in the room (such as doors, couches, beds, tables, etc.,) that are rotated relative to each other and to the walls of the room, each with their own axis, which can create difficulties and confusion when attempting to align the top-down, 2D blueprint-style viewpoint of the room with the natural axis of the computer screen.

One of the chief problems faced in having a user scan a room with their mobile device to generate a 3D model is that the user needs to feel that “things are working,” that the mobile device is capturing the room, and that the computer vision (CV) is functioning correctly. If the user does not feel confident that the scanning process is working correctly, they will often panic and try to adjust their capture techniques to try to make the CV behave as expected, which can result in bad captures and a frustrating user experience.

A need exists for more convenient, robust, and accurate systems and methods that can extract or estimate an accurate room axis.

### BRIEF SUMMARY

Embodiments of the disclosed technology include systems and methods for estimating an axis of a room based on a computer vision (CV) scan of the room and its contents.

In accordance with certain exemplary implementations of the disclosed technology, a computer-implemented method is provided that includes receiving, at a mobile computing device, an input command to initiate capturing visual documentation of an interior environment; capturing, with a camera of the mobile computing device in communication with an augmented reality (AR) engine, a plurality of images of the interior environment, wherein the interior environment comprises one or more walls and a plurality of objects, each wall and object having a surface oriented along a corresponding plane; determining, based on information received from the AR engine, local axis orientations for at least a portion of the walls and objects; estimating a room axis of the interior environment based on a voting process, wherein a majority of matching local axis orientations are utilized to determine the room axis; and outputting an indication of the room axis.

In accordance with certain exemplary implementations of the disclosed technology, a computer system is disclosed for capturing spatial documentation of an environment. The system includes a mobile computing device, comprising: a camera configured to capture video; one or more processors in communication with the camera; an augmented reality (AR) engine in communication with the one or more processors; a first memory configured for storing captured video; a second memory storing computer code that causes the one or more processors to: receive, at a mobile computing device, an input command to initiate capturing visual documentation of an interior environment; capture, with a camera of the mobile computing device in communication with the augmented reality (AR) engine, a plurality of images of the interior environment, wherein the interior environment comprises one or more walls and a plurality of objects, each wall and object having a surface oriented along a corresponding plane; determine, based on information received from the AR engine, local axis orientations for at least a portion of the walls and objects; determine a room axis of the interior environment based on a voting process, wherein a majority of matching local axis orientations are utilized to determine the room axis; and output an indication of the room axis.

Certain exemplary implementations of the disclosed technology include a non-transitory medium with instructions stored thereon that, when executed by a processor of a computing device, cause the computing device to perform operations including receiving, at a mobile computing device, an input command to initiate capturing visual documentation of an interior environment; capturing, with a camera of the mobile computing device in communication with an augmented reality (AR) engine, a plurality of images of the interior environment, wherein the interior environment comprises one or more walls and a plurality of objects, each wall and object having a surface oriented along a corresponding plane; determining, based on information received from the AR engine, local axis orientations for at least a portion of the walls and objects; estimating a room axis of the interior environment based on a voting process, wherein a majority of matching local axis orientations are utilized to determine the room axis; and outputting an indication of the room axis.

Other implementations, features, and aspects of the disclosed technology are described in detail herein and are considered a part of the claimed disclosed technology. Other implementations, features, and aspects can be understood with reference to the following detailed description, accompanying drawings, and claims.

### BRIEF DESCRIPTION OF THE DRAWINGS

Reference will now be made to the accompanying figures and flow diagrams, which are not necessarily drawn to scale.

FIG. 1 illustrates a top-down view illustration of a room for which it is desired to determine the primary room axis, in accordance with certain implementations of the disclosed technology.

FIG. 2 illustrates a top-down view illustration of a room having an object having an axis that is rotated with respect to the room's wall/floor boundaries, in accordance with certain exemplary implementations of the disclosed technology.

FIG. 3A illustrates a top-down view illustration of a room with an overlayed capture path, in accordance with certain exemplary implementations of the disclosed technology.

FIG. 3B illustrates the top-down view illustration as shown in FIG. 3A, where objects in the room have local axes assigned based on their orientation, and a voting process in which the room axis may be estimated based on all assigned axes, in accordance with certain exemplary implementations of the disclosed technology.

FIG. 4 illustrates an example of a computing device that is configured to implement an inspection platform designed to generate measurements of a physical space and objects contained therein, in accordance with certain exemplary implementations of the disclosed technology.

FIG. 5 is a block diagram illustrating an example of a processing system in which at least some operations described herein may be implemented in accordance with certain exemplary implementations of the disclosed technology.

FIG. 6 is a flow diagram of a method in accordance with certain exemplary implementations of the disclosed technology.

Various features of the technology described herein will become more apparent to those skilled in the art from a study of the Detailed Description in conjunction with the drawings. Those skilled in the art will recognize that alternative embodiments may be employed without departing from the principles of the technology. Accordingly, although specific embodiments are shown in the drawings, the technology is amenable to various modifications.

### DETAILED DESCRIPTION

The disclosed technology includes systems and methods that can enable an improved estimation of an axis of an interior physical structure or space (e.g., a room in a house or business) based on a majority voting process in which objects (e.g., chairs, tables, couches, appliances, etc.,) may have their own individually assigned axes that may not match with the axes derived from wall/floor boundaries or other objects in the physical structure or space.

Certain implementations of the disclosed technology may be utilized to improve the process and/or user experience of capturing a computer vision (CV) scan of a room for building a three-dimensional (3D) model of the room and its contents, for example, by providing augmented reality (AR) markers of the features and/or contents of the room so that the user has confidence that the computing/scanning device and associated CV is functioning correctly.

Certain implementations of the disclosed technology include providing live feedback to a user for capturing various different views of the room and associated contents with the aid of spatial information that is output by an augmented reality framework (also called an “AR framework”) on the computing device used for imaging/scanning the associated room.

In certain implementations, the live feedback can include displaying AR markers to represent naturally occurring features in the room. For example, an AR line where a physical wall meets the physical floor may be overlayed on the user's mobile device screen. In certain implementations, a box may be drawn and overlaid around a detected piece of furniture. In both these cases, the displayed line or box may be configured to align precisely with the actual angle of the physical object. Otherwise, if the orientation of the line or box does not match the physical object being represented, wall lines can look like they go “through” the physical walls, and/or boxes around furniture can look askew, which can decrease the user confidence that the computing/scanning device and associated CV is functioning correctly.

In accordance with certain exemplary implementations of the disclosed technology, the estimation of the room axis can provide valuable information for representing the room. In certain implementations, one or more of the AR lines and/or boxed may be “snapped” to the estimated room axes, which can result in the AR overlays providing a better feeling of accurately representing the room.

In accordance with certain exemplary implementations of the disclosed technology, the room scan capture process utilizing the estimated room axis may enable easier understanding and use in the process of construction, maintenance, renovation planning, documentation, underwriting, etc. For example, the disclosed technology may enable a worker to understand the room like a blueprint, or to perform virtual measurements. In certain implementations, a final presentation of a room scan may be a top-down, 2D, blueprint-style viewpoint on a computer screen, which can utilize the natural axis provided by the screen itself, where each pixel can be defined by an X, Y coordinate. In certain implementations, the determination of the room axis may allow easy rotation of the room scan so that the room axes align with the screen's X-Y axes.

As disclosed herein, the room axis may be estimated by majority voting of lines detected in the scene. Therefore, it is likely that much of the room's physical geometry will align with the estimated room axis. Thus, in accordance with certain exemplary implementations of the disclosed technology, most virtual measurements using the presented scan on a computer-screen interface may only need to be in the X or only in the Y direction, which can simplify the measurement and make it easier to export dimensions to further downstream programs.

Various example embodiments of the disclosed technology now will be described more fully hereinafter with reference to the accompanying drawings, in which some, but not all embodiments of the disclosure are shown. This technology may, however, be embodied in many different forms and should not be construed as limited to the implementations set forth herein; rather, these implementations are provided so that this disclosure will be thorough and complete, and will convey the scope of the disclosed technology to those skilled in the art.

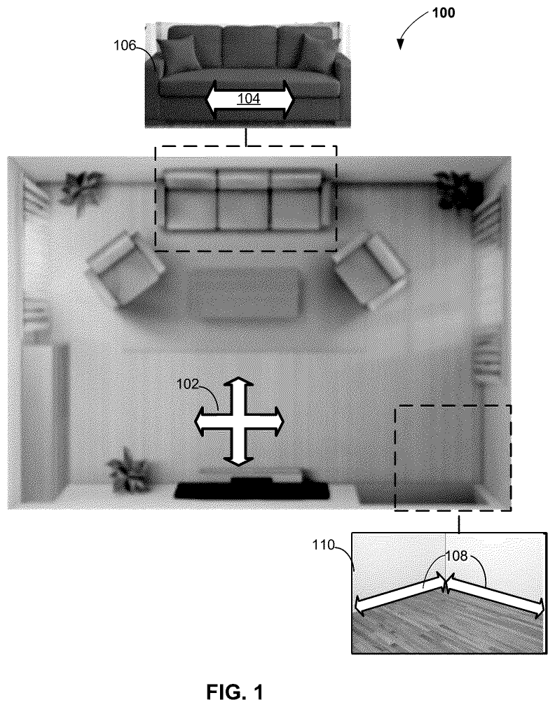

FIG. 1 illustrates a top-down view illustration of a room 100 for which it is desired to determine the primary room axis 102. For this room 100, the direction of lines 104 in a single image of the couch 106 in the room 100, for example, may be used as an estimate for the primary room axis. Similarly, wall/floor border lines 108 in a single image of the corner 110 of the room 100, for example, may be used as an estimate for the primary room axis and/or to affect the confidence of the axis estimate derived from other images of the room, in accordance with certain implementations of the disclosed technology.

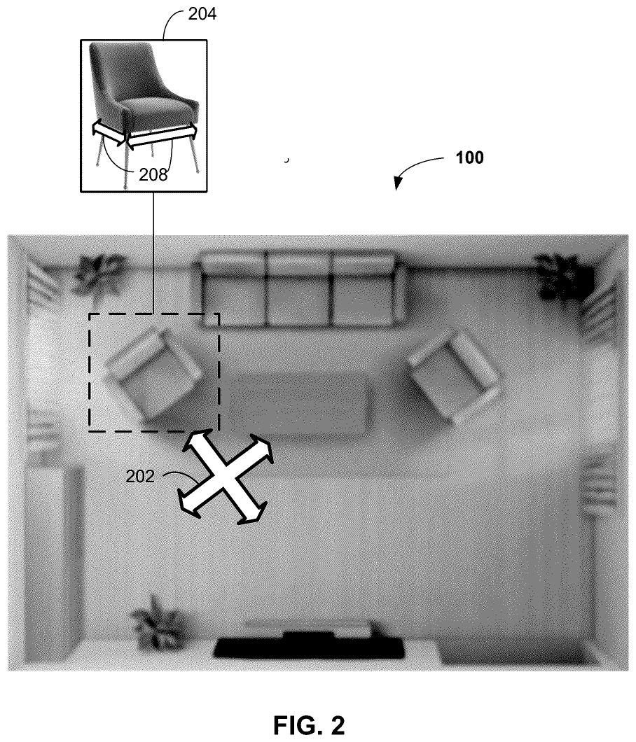

FIG. 2 illustrates a top-down view illustration of the room 100 in which an estimate of the primary room axis 202 may be based on lines 208 in the image of a chair 204, for example, that is rotated with respect to the room's wall/floor boundaries. Therefore, depending on where the image is taken (and objects in the field of view), a different (in this case, incorrect) axis estimate may be generated.

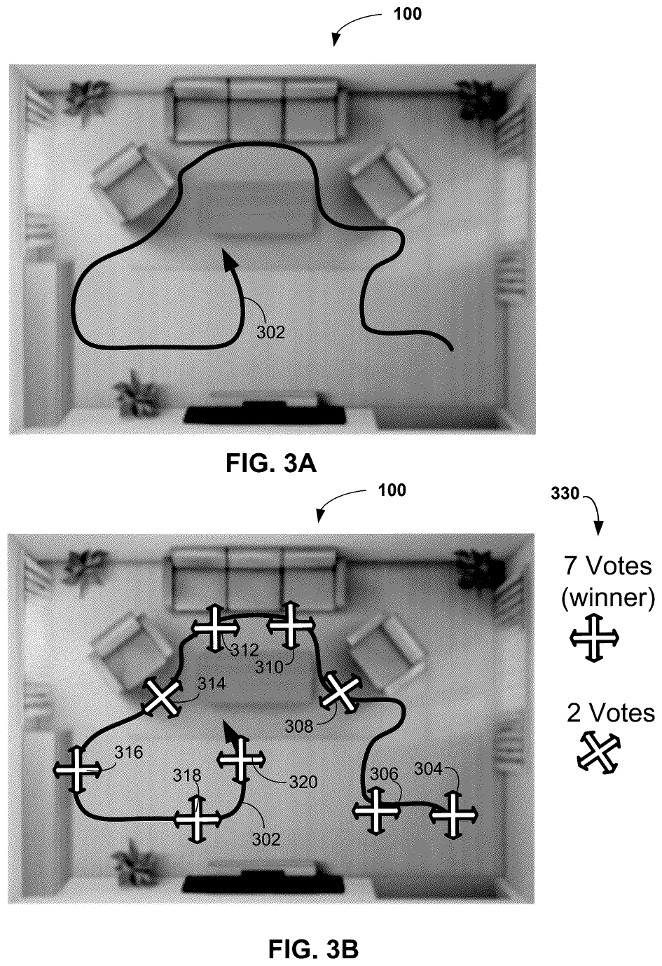

FIG. 3A illustrates a top-down view illustration of the room 100 with an overlayed capture path 302, in accordance with certain exemplary implementations of the disclosed technology.

FIG. 3B illustrates the top-down view illustration of the room 100 as shown in FIG. 3A, where samples from the room along the capture path 302 have local axes 304, 306, 308, 310, 312, 314, 316, 318, 320 determined based on their orientation and from associated lines extracted from the associated images of the objects. To reduce the number of samples which need to be stored in memory, a minimum distance between local axis sample points can be enforced. This effectively sets a maximum number of local axis estimates which can be collected in space with a given square footage area. In accordance with certain exemplary implementations of the disclosed technology, a voting process 330 is illustrated in which the primary room axis may be estimated based on a majority-takes-all vote of the determined local axes. To determine the winner, each local axis estimate may be considered in turn and compared against all the other local axis estimates. The amount of disagreement between two local axes may be determined by the minimum angle needed to rotate one axis estimate into another. The total angular disagreement between each local axis estimate, and all the other local axis estimates may be computed, and the local axis estimate with the minimum total disagreement may be chosen as the winner to represent the axis of the entire space.

In certain implementations, if a user retraces their capture path 302 and gets within a predetermined distance of an existing determined local axes, the existing determined local axes may be updated. Thus, in accordance with certain exemplary implementations of the disclosed technology, the number of determined local axes may be bound to a maximum number, even if the user retraces their path many times during the scanning process.

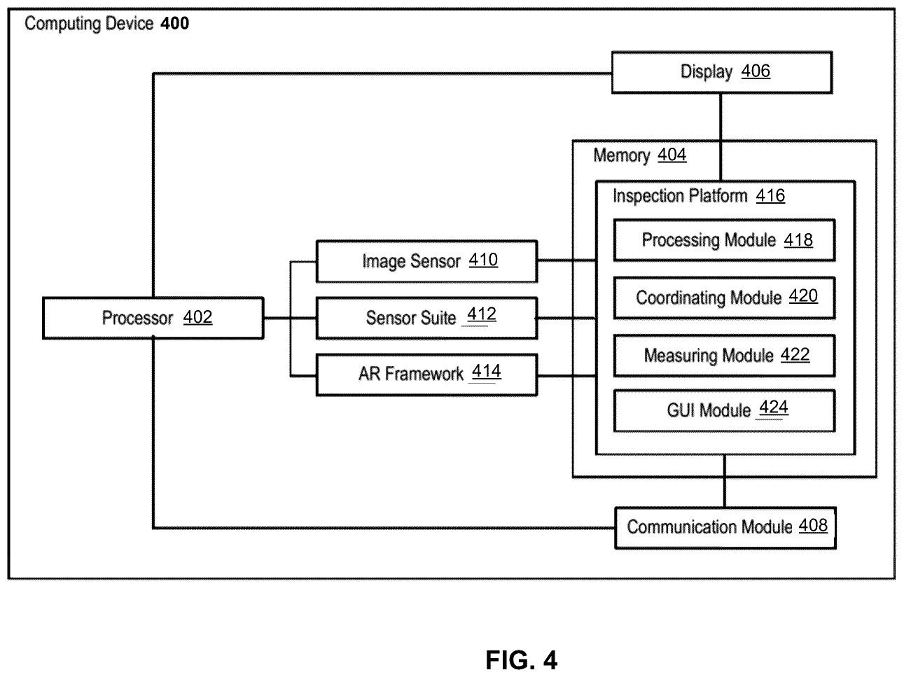

FIG. 4 illustrates an example of a computing device 400 that is configured to implement an inspection platform 416 designed to generate measurements of a physical space and objects contained therein. The physical space could be an interior space or exterior space. The inspection platform 416 may generate the measurements based on an analysis of digital images of the physical space. As further discussed below, these digital images can be acquired during a guided measurement operation in which a user is prompted to reposition the computing device 400 through the use of digital elements.

The computing device 400 can include a processor 402, memory 404, display 406, communication module 408, image sensor 410 (such as a camera), and sensor suite 412. Each of these components is discussed in greater detail below. Those skilled in the art will recognize that different combinations of these components may be present depending on the nature of the computing device 400.

The processor 402 may have generic characteristics similar to general-purpose processors, or the processor 402 may be an application-specific integrated circuit (ASIC) that provides control functions to the computing device 400. As shown in FIG. 4, the processor 402 can be coupled to all components of the computing device 400, either directly or indirectly, for communication purposes.

The memory 404 may include any suitable type of storage medium, such as static random-access memory (SRAM), dynamic random-access memory (DRAM), electrically erasable programmable read-only memory (EEPROM), flash memory, or registers. In addition to storing instructions that can be executed by the processor 402, the memory 404 can also store data generated by the processor 402 (e.g., when executing the modules of the inspection platform 416). The memory 404 may be an abstract representation of a storage environment. The memory 404 may include actual memory integrated circuits (also referred to as “chips”).

In accordance with certain exemplary implementations of the disclosed technology, the display 406 can be any mechanism that is operable to visually convey information to a user. For example, the display 406 may be a panel that includes light-emitting diodes (LEDs), organic LEDs, liquid crystal elements, or electrophoretic elements. In some embodiments, the display 406 may be touch sensitive. Thus, a user may be able to provide input to the inspection platform 416 by interacting with the display 406.

The communication module 408 may be responsible for managing communications between the components of the computing device 400, or the communication module 408 may be responsible for managing communications with other computing devices (e.g., server system 108 of FIG. 1). The communication module 408 may be wireless communication circuitry that is designed to establish communication channels with other computing devices. Examples of wireless communication circuitry include chips configured for Bluetooth, Wi-Fi, NFC, and the like.

The image sensor 410 may be any electronic sensor that is able to detect and convey information in order to generate digital images, generally in the form of image data or pixel data. Examples of image sensors include charge-coupled device (CCD) sensors and complementary metal-oxide semiconductor (CMOS) sensors. The image sensor 410 may be implemented in a camera module (or simply “camera”) that is implemented in the computing device 400. In some embodiments, the image sensor 410 is one of multiple image sensors implemented in the computing device 400. For example, the image sensor 410 could be included in a front- or rear-facing camera on a mobile phone (or smartphone).

Other sensors may also be installed in the computing device 400. Collectively, these sensors may be referred to as the “sensor suite” 412 of the computing device 400. For example, the computing device 400 may include a motion sensor whose output is indicative of motion of the computing device 400 as a whole. Examples of motion sensors include accelerometers and gyroscopes. In some embodiments, the motion sensor is implemented in an inertial measurement unit (IMU) that measures the force, angular rate, or orientation of the computing device 400. The IMU may accomplish this through the use of one or more accelerometers, one or more gyroscopes, one or more magnetometers, or any combination thereof. As another example, the computing device 400 may include a proximity sensor whose output is indicative of proximity of the computing device 400 to a nearest obstruction within the field of view of the proximity sensor. A proximity sensor may include, for example, an emitter that is able to emit infrared (IR) light and a detector that is able to detect reflected IR light that is returned toward the proximity sensor. These types of proximity sensors are sometimes called laser imaging, detection, and ranging (LiDAR) sensors. As another example, the computing device 400 may include an ambient light sensor whose output is indicative of the amount of light in the ambient environment.

The computing device 400 may also implement an AR framework 414. The AR framework 414 is normally executed by the operating system of the computing device 400 rather than any individual computer program executing on the computing device 400. The AR framework 414 may integrate (i) digital images that are generated by the image sensor 410 and (ii) outputs produced by one or more sensors included in the sensor suite 412 in order to determine the location of the computing device 400 in 3D space. At a high level, the AR framework 414 may perform motion tracking, scene capturing, and scene processing to establish the spatial position of the computing device 400 in real time. Generally, the AR framework 414 is accessible to computer programs executing on the computing device 400 via an application programming interface (API). Thus, the inspection platform 414 may be able to readily obtain spatial positions from the AR framework 414 via the API as further discussed below.

For convenience, the inspection platform 416 may be referred to as a computer program that resides within the memory 404. However, the inspection platform 414 could include software, firmware, or hardware that is implemented in, or accessible to, the computing device 400. In accordance with embodiments described herein, the inspection platform 416 may include a processing module 418, coordinating module 420, measuring module 422, and graphical user interface (GUI) module 424. Each of these modules can be an integral part of the inspection platform 416. Alternatively, these modules can be logically separate from the inspection platform 416 but operate “alongside” it. Together, these modules enable the inspection platform 416 to generate measurements of a physical space, as well as obtained contained therein, in an automated manner by guiding a user through a measurement operation.

In accordance with certain exemplary implementations of the disclosed technology, the processing module 418 may process data obtained by the inspection platform 416 into a format that is suitable for the other modules. For example, the processing module 418 may apply operations to digital images generated by the image sensor 410 in preparation for analysis by the other modules of the inspection platform 416. Thus, the processing module 418 may despeckle, denoise, or otherwise filter images that are generated by the image sensor 410. Additionally, or alternatively, the processing module 418 may adjust properties like contrast, saturation, and gain in order to improve the outputs produced by the other modules of the inspection platform 416.

The processing module 418 may also process data obtained from the sensor suite 412 in preparation for analysis by the other modules of the inspection platform 416. As further discussed below, the inspection platform 416 may utilize data that is generated by a motion sensor in order to better understand data that is generated by the image sensor 410. For example, the inspection platform 416 may programmatically combine digital images generated by the image sensor 410 based on measurements generated by the motion sensor, so as to create a panorama of the physical space. Moreover, the inspection platform 416 may determine, based on the measurements, an approximate location of each digital image generated by the image sensor 410 and then use those insights to establish dimensions of the physical space and objects contained therein. Alternatively, the inspection platform 416 may infer, based on the measurements, movements of the computing device 400 as digital images are generated by the image sensor 410. For example, the inspection platform 416 may be able to determine a direction and magnitude of movements of the computing device 400 based on an analysis of the measurements. To accomplish this, the measurements generated by the motion sensor may be temporally aligned with the digital images generated by the image sensor 410. The processing module 418 may be responsible for ensuring that these data are temporally aligned with one another, such that the inspection platform 416 can readily identify the measurement(s) that correspond to each digital image.

The coordinating module 420 may be responsible for determining and/or cataloguing the locations of points of interest. In an example implementation, a user may be interested in establishing the dimensions of a physical space. The periphery of the physical space may be defined by junctures. The term “juncture” may refer to any location where a pair of walls join, intersect, or otherwise merge or converge with one another. The term “juncture” as used herein is intended to cover corners where the walls form acute, obtuse, or reflex angles (a reflex angle is defined as an angle whose measure is greater than 180° but less than 360°). Therefore, the teachings of the disclosed technology may be applicable to structures regardless of their particular configuration. In order to “map” the periphery of the physical space, the inspection platform 416 may request that the user locate the computing device 400 in a certain position (e.g., proximate the center of the physical space) and then capture a panorama of the physical space by panning the computing device 400. The coordinating module 420 may be responsible for determining, based on an analysis of the panorama, where the junctures of the physical space are located. As further discussed below, this can be accomplished by applying a trained model to the panorama. The trained model may produce, as output, coordinates indicating where a juncture is believed to be located based on pixel-level examination of the panorama. The trained model may produce a series of outputs that are representative of different junctures of the physical space. Using the series of outputs, the coordinating module 420 can “reconstruct” the physical space, thereby establishing its dimensions.

The measuring module 422 may be utilized to examine the locations of junctures determined by the coordinating module 420 in order to derive information about the physical space being imaged. For example, the measuring module 422 may calculate a dimension of the physical space based on a comparison of multiple locations (e.g., a width defined by a pair of wall-wall boundaries, or a height defined by the floor-wall and ceiling-wall boundaries). As another example, the measuring module 422 may generate a 2D or 3D layout using the locations. Thus, the measuring module 422 may be able to construct a 2D or 3D model of the physical space based on the information gained through analysis of a single panorama. In some embodiments, the measuring module 422 is also responsible for cataloging the locations of junctures determined by the coordinating module 420. Thus, the measuring module 422 may store the locations in a data structure that is associated with either the physical space or a building with which the physical space is associated. Information derived by the measuring module 422, such as dimensions and layouts, can also be stored in the data structure. In some embodiments each location is represented using a coordinate system (e.g., a geographic coordinate system such as the Global Positioning System) that is associated with real-world positions, while in other embodiments each location is represented using a coordinate system that is associated with the surrounding environment. For example, the location of each juncture may be defined with respect to the location of the computing device 400.

As mentioned above, generating digital images of the physical space in its entirety—or at least the portion to be measured—can help ensure that the information derived by the measuring module 422 is accurate. To ensure that this occurs, the inspection platform 416 can prompt the user to move the computing device in a particular manner as digital images are generated during the measurement operation. The computing device 400, for example, may be positioned in either the vertical or horizontal orientation with a vertical plane defined therethrough. In such a scenario, the inspection platform 416 may prompt the user to move the computing device along the vertical plane, for example, in a shape that is dictated by a digital element presented on the display 406.

In accordance with certain exemplary implementations of the disclosed technology, as digital images are generated by the image sensor 410 over the course of the measurement operation, those digital images may be presented on the display 406 in the form of a video feed. To provoke the user to move the computing device 400, the GUI module 424 may cause a digital feature to be overlaid on the video feed. At a high level, the digital feature may be representative of an augmented reality component that is intended to provoke the user into moving the computing device 400 in a predetermined manner via live feedback.

As further discussed below, the digital feature may be responsive to movements along the vertical plane. In some embodiments, movements of the computing device 400 may be inferred based on an analysis of measurements generated by a sensor included in the sensor suite 412. For example, the inspection platform 416 may infer the direction and magnitude of the movements based on measurements generated by a motion sensor included in the computing device 400. In other embodiments, movements of the computing device 400 may be determined based on an analysis of spatial information output by the AR framework. Digital images generated by the image sensor 410 may be provided, as input, to the AR framework over the course of a measurement operation as mentioned above. Whenever a digital image is provided to the AR framework as input, the AR framework may generate spatial information, including an estimated spatial position of the computing device 400 when the digital image was generated. Through analysis of these spatial positions estimated by the AR framework, the inspection platform 416 may be able to determine whether the spatial position of the computing device 400 has changed (and therefore, whether the appearance of the digital feature should be altered).

In certain exemplary implementations, the GUI module 424 may also be responsible for generating interfaces that can be presented on the display 406. Various types of information can be presented on these interfaces. For example, information that is calculated, derived, or otherwise obtained by the coordinating module 420 and/or measuring module 422 may be presented on an interface for display to the user. As another example, visual feedback may be presented on an interface so as to indicate to the user whether the measurement operation is being completed properly.

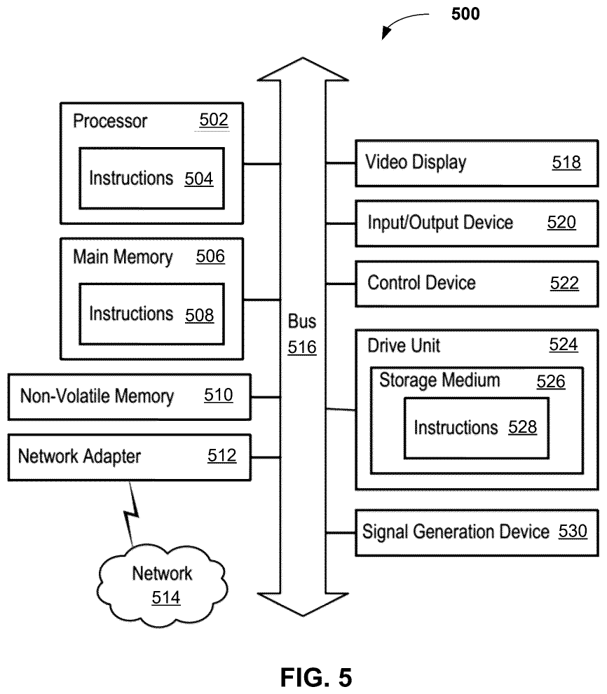

FIG. 5 is a block diagram illustrating an example of a processing system 500 in which at least some operations described herein can be implemented. For example, components of the processing system 500 may be hosted on a computing device that includes an inspection platform, or components of the processing system 500 may be hosted on a computing device with which images of an interior space are captured.

The processing system 500 may include a central processing unit (“processor”) 502, main memory 506, non-volatile memory 510, network adapter 512, video display 518, input/output device 520, control device 522 (e.g., a keyboard or pointing device), drive unit 524 including a storage medium 526, and signal generation device 530 that are communicatively connected to a bus 516. The bus 516 is illustrated as an abstraction that represents one or more physical buses or point-to-point connections that are connected by appropriate bridges, adapters, or controllers. The bus 516, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), inter-integrated circuit (I²C) bus, or an Institute of Electrical and Electronics Engineers (IEEE) standard 1394 bus (also referred to as “Firewire”).

While the main memory 506, non-volatile memory 510, and storage medium 526 are shown to be a single medium, the terms “machine-readable medium” and “storage medium” should be taken to include a single medium or multiple media (e.g., a centralized/distributed database and/or associated caches and servers) that store one or more sets of instructions 528. The terms “machine-readable medium” and “storage medium” shall also be taken to include any medium that is capable of storing, encoding, or carrying a set of instructions for execution by the processing system 500.

In general, the routines executed to implement the embodiments of the disclosure may be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in a computing device. When read and executed by the processors 502, the instruction(s) cause the processing system 500 to perform operations to execute elements involving the various aspects of the present disclosure.

Further examples of machine- and computer-readable media include recordable-type media, such as volatile memory devices and non-volatile memory devices 510, removable disks, hard disk drives, and optical disks (e.g., Compact Disk Read-Only Memory (CD-ROMS) and Digital Versatile Disks (DVDs)), and transmission-type media, such as digital and analog communication links.

The network adapter 512 may enable the processing system 500 to mediate data in a network 514 with an entity that is external to the processing system 500 through any communication protocol supported by the processing system 500 and the external entity. The network adapter 512 can include a network adaptor card, a wireless network interface card, a router, an access point, a wireless router, a switch, a multilayer switch, a protocol converter, a gateway, a bridge, bridge router, a hub, a digital media receiver, a repeater, or any combination thereof.

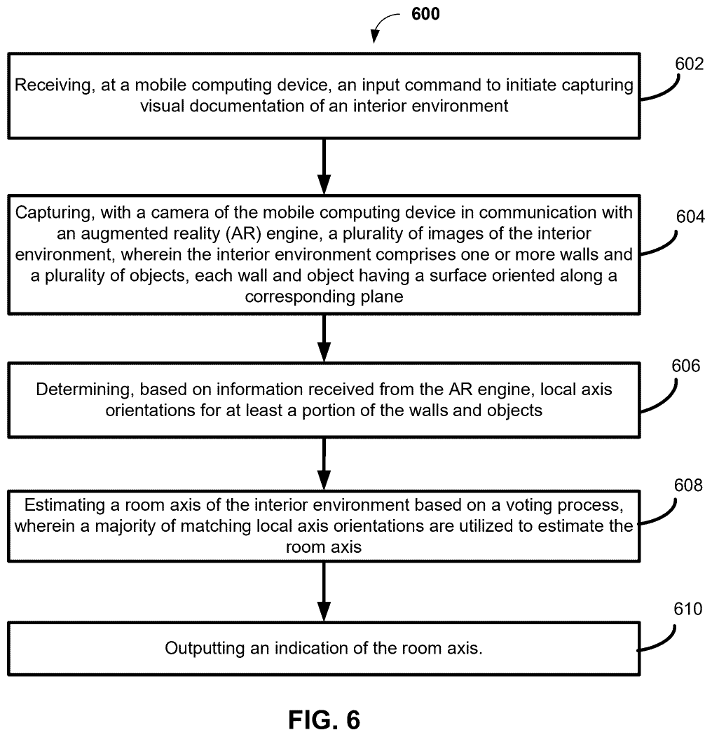

FIG. 6 is a flow diagram of a method 600 for estimating a room axis, in accordance with certain exemplary implementations of the disclosed technology. In block 602, the method 600 includes receiving, at a mobile computing device, an input command to initiate capturing visual documentation of an interior environment. In block 604, the method 600 includes capturing, with a camera of the mobile computing device in communication with an augmented reality (AR) engine, a plurality of images of the interior environment, wherein the interior environment comprises one or more walls and a plurality of objects, each wall and object having a surface oriented along a corresponding plane. In block 606, the method 600 includes determining, based on information received from the AR engine, local axis orientations for at least a portion of the walls and objects. In block 608, the method 600 includes estimating a room axis of the interior environment based on a voting process, wherein a majority of matching local axis orientations are utilized to determine the room axis. In block 610, the method 600 includes outputting an indication of the room axis.

Certain implementations of the disclosed technology can further include outputting annotations corresponding to the local axis orientations. In certain implementations, outputting at least a portion of the annotations may be performed during the capturing to provide feedback to the user. In certain implementations, the annotations can align with the local axis orientations and correspond to locations and angles where the objects are physically placed in the interior environment. In certain implementations, the annotations may align with the local axis orientations and correspond to locations and angles where physical walls meet a physical floor.

In certain implementations, the plurality of images may be captured as a user moves to different locations in the interior environment.

In certain implementations, visual documentation can include a three-dimensional (3D) mapping of the interior environment.

Certain implementations of the disclosed technology can include capturing measurements of the interior environment based on the estimated room axis. In certain exemplary implementations, the measurements can include one or more of dimensions and angles.

In accordance with certain exemplary implementations of the disclosed technology, the interior environment can include one or more of a kitchen, a living room, a utility room, an office, a bedroom, a bathroom, a garage, and the like.

Certain implementations of the disclosed technology may utilize an AR framework and inertial data generated by one or more position sensors of a mobile computing device to scan and/or map an interior environment. In certain exemplary implementations, the one or more position sensors can include an accelerometer, a gyroscope, and/or the like. Certain implementations can include outputting instructions to prompt a user to move the computing device in a predetermined manner to capture the room scan. Certain implementations can include displaying live feedback to prompt the user to adjust movement of the computing device as the digital images are being captured. In certain exemplary implementations, the computing device is a smartphone or a tablet. In some implementations, the computing device may include or be associated with a drone.

In certain exemplary implementations, captured spatial information can include spatial coordinates, each of which is indicative of a spatial position of the computing device when a corresponding digital image was captured, and wherein the AR framework produces the corresponding spatial position as output for each captured digital image.

In certain exemplary implementations, the AR framework may be provided by a commercially available AR engine that may execute on a computing device and may perform visual inertial odometry using the computing device camera, processors, and motion/location sensors to track the surroundings and/or to sense how the computing device is moved around a space. Examples of currently available AR frameworks that may be utilized in conjunction with the disclosed technology are as discussed in the Apple Developer ARKit documentation (https://developer.apple.com/documentation/arkit/), or in the Google ARCore documentation (https://developers.google.com/ar/develop), each of which are incorporated herein by reference as if presented in full.

Since Augmented Reality (AR) engines are widely available on modern mobile devices, certain implementations of the disclosed technology may utilize an AR engine to automatically capture relative positions and orientations (i.e., poses) of the camera in the world coordinate system while each of the images is captured. In situations where the AR system is not available, the relative pose of the cameras may be obtained by using any number of “relative pose from points” techniques. However, for certain implementations of the disclosed technology, the world coordinate capture positions and orientations of images are known or may be derived. Furthermore, in accordance with certain exemplary implementations of the disclosed technology, the AR engine may produce position estimates, which may be utilized by the disclosed technology, for example, to provide certain feedback to the user during the imaging/scanning of the room, and/or the determination of positions of the contents and features of the room.

The disclosed technology includes methods that can be implemented via computer program instructions executing on a computing device. For example, the instructions may cause the computing device to receive input that represents a request to establish the dimensions of a structure in an interior space via a scanning process. Such input can correspond to a user either initiating (i.e., opening) the computer program or interacting with the computer program in such a manner so as to initiate measuring the structure. Responsive to the received input to initiate measuring, the computer program can then invoke an AR framework that is executable by the computing device.

The AR framework may be executed “in the background” by the operating system of the computing device, and thus may not be executed by the computer program itself. Instead, the computer program may acquire spatial information from the AR framework when needed. For example, the ARWorldTrackingConfiguration class of the ARKit may be invoked to track the computing device movement with six degrees of freedom the three rotation axes (roll, pitch, and yaw), and three translation axes (movement in x, y, and z).

The ARPositionalTrackingConfiguration class of the ARKit can enable 6 degrees of freedom tracking of the computing device by running the camera at lowest possible resolution and frame rate. Such device tracking information may be made available to the computer program executing on the computing device and may be utilized by the disclosed technology to detect the position of the computing device and (associated camera) while images are captured by the camera. Such device tracking and/or position information may be utilized to select and/or vary the appearance of an overlay on the computing device's display as a form of guided live feedback to instruct the user to move the computing device/camera in a particular pattern so that multiple different views of the scene and/or structure may be imaged, for example, to provide additional or enhanced information regarding structures or objects in the digital images. In certain implementations, the movement of the camera and processing of the digital images may provide a “synthetic parallax” which can be used to extract depth information about structures or objects in the digital images. In certain exemplary implementations, this enhanced information regarding structures or objects in the digital images may be used for many different purposes, including but not limited to structural measurements, object measurements, object recognition, detection of objects, detection of a condition of objects, safety hazards, etc.

As part of the measurement process, the user may be prompted to position the computing device so that digital images of the structure can be generated. To measure the structure, the computer program may utilize and combine information derived through analysis of the digital images as discussed in U.S. application Ser. No. 17/500,128, titled “Generating Measurements of Physical Structures and Environments Through Automated Analysis of Sensor Data,” filed 13 Oct. 2021, and published as U.S. Patent Application Publication US20220114298 on 14 Apr. 2022, the contents of which is hereby incorporated by reference in their entirety as if presented herein in full. More specifically, the computer program may enable or facilitate measurement of the structure based on (i) the digital images generated by the image sensor and (ii) measurements generated by an inertial sensor (also referred to as a “motion sensor”), which, as discussed above, may be advantageous since the digital images provide a visual representation of the structure up to an unknown scale factor, while the inertial measurements (also referred to as “motion measurements”) provide an estimate of the unknown scale factor. Together, these data enable estimates of measurements of the structure.

Measurement accuracy can be improved if digital images are generated of the structure from multiple spatial positions, so that greater coverage of the structure is obtained. In an example scenario, a first digital image of a structure may be captured from a first spatial position and a second digital image of the structure may be captured from a second spatial position. Capturing the first and second digital images from different spatial positions may enable the computer program to estimate the measurements of the structure from different perspectives. Simply put, the first and second digital images provide more information about the structure (and interior space as a whole) than would multiple digital images captured from the same perspective. Capturing digital images from multiple perspectives may also enable other features. For example, a digital representation of the structure could be more easily created if the digital images captured more of its surface.

Certain embodiments are described in the context of generating measurements for structures in interior spaces for illustration. Examples of structures include the floor, ceiling, and walls of the interior space, as well as obtained contained therein such as furniture. However, the approach described herein may also be suitable for improving the coverage of digital images of structures in exterior spaces. Generally, the term “interior space” is used to refer to a physical space inside a building of interest. The term “exterior space,” meanwhile, may be used to refer to a physical space that is external to the building of interest. Examples of exterior spaces include driveways, decks, and the like.

Certain implementations described herein for the purpose of illustration may be in the context of executable instructions. However, those skilled in the art will recognize that aspects of the technology could be implemented via hardware, firmware, or software. As an example, a computer program that is representative of a software-implemented inspection platform (or simply “inspection platform”) designed to facilitate imaging and measuring of interior spaces or exterior spaces may be executed by the processor of a computing device. This computer program may interface, directly or indirectly, with hardware, firmware, or other software implemented on the computing device.

In the foregoing description, references to “an embodiment” or “certain embodiments” mean that the feature, function, structure, or characteristic being described is included in at least one embodiment. Occurrences of such phrases do not necessarily refer to the same embodiment, nor are they necessarily referring to alternative embodiments that are mutually exclusive of one another.

The term “based on” is to be construed in an inclusive sense rather than an exclusive sense. That is, in the sense of “including but not limited to.” Thus, unless otherwise noted, the term “based on” is intended to mean “based at least in part on.”

The terms “connected,” “coupled,” and variants thereof are intended to include any connection or coupling between two or more elements, either direct or indirect. The connection or coupling can be physical, logical, or a combination thereof. For example, elements may be electrically or communicatively coupled to one another despite not sharing a physical connection.

The term “module” may refer broadly to software, firmware, hardware, or combinations thereof. Modules are typically functional components that generate one or more outputs based on one or more inputs. A computer program may include or utilize one or more modules. For example, a computer program may utilize multiple modules that are responsible for completing different tasks, or a computer program may utilize a single module that is responsible for completing all tasks.

When used in reference to a list of multiple items, the word “or” is intended to cover all of the following interpretations: any of the items in the list, all of the items in the list, and any combination of items in the list.

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

What is claimed:

1. A computer-implemented method for estimating a room axis, comprising:
receiving, at a mobile computing device, an input command to initiate capturing visual documentation of an interior environment;
capturing, with a camera of the mobile computing device in communication with an augmented reality (AR) engine, a plurality of images of the interior environment, wherein the interior environment comprises one or more walls and a plurality of objects, each wall and object having a surface oriented along a corresponding plane;
determining, based on information received from the AR engine, local axis orientations for at least a portion of the walls and objects;
estimating a room axis of the interior environment based on a voting process, wherein a majority of matching local axis orientations are utilized to estimate the room axis; and
outputting an indication of the room axis.

2. The method of claim 1, further comprising outputting annotations corresponding to the local axis orientations.

3. The method of claim 2, wherein outputting at least a portion of the annotations is performed during the capturing to provide feedback to a user.

4. The method of claim 2, wherein the annotations align with the local axis orientations and correspond to locations and angles where the objects are physically placed in the interior environment.

5. The method of claim 2, wherein the annotations align with the local axis orientations and correspond to locations and angles where physical walls meet a physical floor.

6. The method of claim 1, wherein the plurality of images are captured as a user moves to different locations in the interior environment.

7. The method of claim 1, wherein the visual documentation comprises a three-dimensional (3D) mapping of the interior environment.

8. The method of claim 1, further comprising capturing dimensions of the interior environment based on the estimated room axis.

9. The method of claim 1, wherein the interior environment comprises one or more of a kitchen, a living room, a utility room, an office, a bedroom, a bathroom, and a garage.

10. A system for capturing spatial documentation of an environment, comprising:
a mobile computing device, comprising:
a camera configured to capture video;
one or more processors in communication with the camera;
an augmented reality (AR) engine in communication with the one or more processors;
a first memory configured for storing captured video;
a second memory storing computer code that causes the one or more processors to:
receive, at a mobile computing device, an input command to initiate capturing visual documentation of an interior environment;
capture, with a camera of the mobile computing device in communication with the augmented reality (AR) engine, a plurality of images of the interior environment, wherein the interior environment comprises one or more walls and a plurality of objects, each wall and object having a surface oriented along a corresponding plane;
determine, based on information received from the AR engine, local axis orientations for at least a portion of the walls and objects;
estimate a room axis of the interior environment based on a voting process, wherein a majority of matching local axis orientations are utilized to estimate the room axis; and
output an indication of the room axis.

11. The system of claim 10, wherein the computer code further causes the one or more processors to output, for display on the mobile computing device, annotations corresponding to the local axis orientations.

12. The system of claim 11, wherein at least a portion of the annotations are output during the capturing to provide feedback to a user.

13. The system of claim 11, wherein the annotations align with the local axis orientations and correspond to locations and angles where the objects are physically placed in the interior environment.

14. The system of claim 11, wherein the annotations align with the local axis orientations and correspond to locations and angles where physical walls meet a physical floor.

15. The system of claim 10, wherein the plurality of images are captured as a user moves to different locations in the interior environment.

16. The system of claim 10, wherein the visual documentation comprises a three-dimensional (3D) mapping of the interior environment.

17. The system of claim 10, wherein the computer code further causes the one or more processors to capture dimensions of the interior environment based on the estimated room axis.

18. A non-transitory computer-readable medium with instructions stored thereon that, when executed by a processor of a computing device, cause the computing device to perform operations comprising:
receiving, at a mobile computing device, an input command to initiate capturing visual documentation of an interior environment;
capturing, with a camera of the mobile computing device in communication with an augmented reality (AR) engine, a plurality of images of the interior environment, wherein the interior environment comprises one or more walls and a plurality of objects, each wall and object having a surface oriented along a corresponding plane;
determining, based on information received from the AR engine, local axis orientations for at least a portion of the walls and objects;
estimating a room axis of the interior environment based on a voting process, wherein a majority of matching local axis orientations are utilized to estimate the room axis; and
outputting an indication of the room axis.

19. The non-transitory computer-readable medium of claim 18, wherein the instructions further cause the computing device to output, for display, annotations corresponding to the local axis orientations, wherein outputting at least a portion of the annotations is performed during the capturing to provide feedback to a user while the plurality of images are captured as a user moves to different locations in the interior environment.

20. The non-transitory computer-readable medium of claim 18, wherein the annotations align with the local axis orientations and correspond to locations and angles where the objects are physically placed in the interior environment or where physical walls meet a physical floor.
